(19) United States
(12) Patent Application Publication
(10) Pub. No.: US 2024/0288799 A1
(43) Pub. Date: Aug. 29, 2024

(54) ENDLESS BELT, TRANSFER UNIT, AND IMAGE FORMING APPARATUS

(71) Applicant: FUJIFILM Business Innovation Corp., Tokyo (JP)

(72) Inventors: Minoru ROKUTAN, Kanagawa (JP); Shogo HAYASHI, Kanagawa (JP)

(73) Assignee: FUJIFILM Business Innovation Corp., Tokyo (JP)

(21) Appl. No.: 18/359,204

(22) Filed: Jul. 26, 2023

(30) Foreign Application Priority Data
Feb. 24, 2023 (JP) 2023-027788

(51) Int. Cl. G03G 15/16; G03G 15/20

(52) U.S. Cl. CPC G03G 15/162; G03G 15/2053; G03G 15/2064; G03G 2215/2038

(57) ABSTRACT

An endless belt includes: an endless belt substrate; and a belt-shaped rib member that is provided in a peripheral direction along at least one end portion in a width direction of an inner peripheral surface of the belt substrate, in which the rib member is conductive.

### CROSS-REFERENCE TO RELATED APPLICATIONS

This application is based on and claims priority under 35 USC 119 from Japanese Patent Application No. 2023-027788 filed Feb. 24, 2023.

### BACKGROUND

### (i) Technical Field

The present disclosure relates to an endless belt, a transfer unit, and an image forming apparatus.

### (II) Related Art

For example, JP2009-109524A discloses “a belt transport device for an image forming apparatus, the belt transport device including: an endless belt; and a plurality of rollers that stretch the endless belt, in which a rib member is provided along at least one side end of an inner peripheral surface of the endless belt, a guide portion that freely rotates and includes a guide surface with which an end portion of the rib member comes into contact to be guided is provided at least one of the rollers, and a low friction layer where a coefficient of friction with the guide portion is 0.1 or less is provided on a surface of the rib member.

### SUMMARY

Aspects of non-limiting embodiments of the present disclosure relate to an endless belt that includes: an endless belt substrate; and a belt-shaped rib member that is provided in a peripheral direction along at least one end portion in a width direction of an inner peripheral surface of the belt substrate, in which the amount of dust attached to the rib member can be reduced as compared to a case where the rib member is insulating.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

Means for addressing the above object include the following aspect.

According to an aspect of the present disclosure, there is provided an endless belt including an endless belt substrate; and a belt-shaped rib member that is provided in a peripheral direction along at least one end portion in a width direction of an inner peripheral surface of the belt substrate, in which the rib member is conductive.

### BRIEF DESCRIPTION OF THE DRAWINGS

Exemplary embodiment(s) of the present invention will be described in detail based on the following figures, wherein:

FIGS. 1A and 1B are schematic diagrams showing an example of a measuring device that measures volume resistivities of a belt substrate and a rib member in an endless belt, in which FIG. 1B is a plan view and FIG. 1A is a cross-sectional view take along line A-A′ of FIG. 1B;

FIG. 2 is a partial cross-sectional view showing an example of a configuration of the endless belt according to the present disclosure;

FIG. 3 is an enlarged schematic diagram showing a partial cross-section represented by C in the endless belt shown in FIG. 2;

FIG. 4 is a schematic diagram showing an example of a configuration of a transfer unit according to the present disclosure;

FIG. 5 is a partial cross-sectional view showing an example of a meandering control member guide of the transfer unit according to the present disclosure;

FIG. 6 is a partial cross-sectional view showing another example of the meandering control member guide of the transfer unit according to the present disclosure; and

FIG. 7 is a schematic diagram showing an example of a configuration of an image forming apparatus according to the present disclosure.

### DETAILED DESCRIPTION

Hereinafter, an exemplary embodiment that is an example of the present invention will be described in detail with reference to the drawings. The following description and examples are merely exemplary of the exemplary embodiment, and do not limit the scope of the exemplary embodiment.

An upper limit value or a lower limit value described in one numerical range described in a stepwise manner in the present disclosure may be replaced with an upper limit value or a lower limit value in another numerical range described in a stepwise manner. In addition, an upper limit value or a lower limit value in a numerical range described in the present disclosure may be replaced with a value described in Examples.

In the present disclosure, the term “step” represents not only an individual step but also a step which is not clearly distinguishable from another step as long as an effect expected from the step can be achieved.

In the present disclosure, in a case where an exemplary embodiment is described with reference to drawings, the configuration of the present exemplary embodiment is not limited to the configuration shown in the drawings. In addition, the sizes of members in each of the drawings are conceptual and do not limit the relative relationship between the sizes of the members. Further, members having the same functions and actions are represented by the same reference numerals throughout the drawings, and descriptions thereof will not be repeated.

In the present disclosure, each of components may include plural kinds of materials corresponding to the component. In a case where plural kinds of materials corresponding to each of components in a composition are present in the present disclosure, unless specified otherwise, the amount of each of the components in the composition refers to the total amount of the plural kinds of materials present in the composition.

### Endless Belt

An endless belt according to the present disclosure includes: an endless belt substrate; and a belt-shaped rib member that is provided in a peripheral direction along at least one end portion in a width direction of an inner peripheral surface of the belt substrate, in which the rib member is conductive.

Here, “conductivity” in the present disclosure represents that a volume resistivity at 20° C. is less than 1×10¹³ Ωcm. That is, in the rib member in the endless belt according to the present disclosure, a volume resistivity at 20° C. is less than 1×10¹³ Ωcm. In the present disclosure, it is assumed that “volume resistivity” described in any portion is a volume resistivity at 20° C.

Here, “insulating” in the present disclosure represents that a volume resistivity at 20° C. is 1×10¹³ Ωcm or more.

The rib member in the endless belt has a function of coming into contact with a roller for rotating the endless belt to control the meandering of the endless belt. Therefore, during the rotation of the endless belt, the rib member and the roller are rubbed such that the rib member is frictionally charged and dust such as toner or paper powder is collected by static electricity. As the amount of the dust collected by the rib member increases, the dust is fixed by heat and pressure to form a large lump (for example, a lump having a diameter of 500 m or more). In a case where the lump of the dust is attached to the belt substrate side in the endless belt, for example, in a case where the endless belt is a transfer belt, transfer failure may occur.

In the endless belt according to the present disclosure, as described above, the rib member is conductive. Therefore, during the rotation of the endless belt, even in a case where the rib member and the roller are rubbed, the rib member is not likely to be charged. As a result, the amount of dust attached to the rib member can be reduced.

That is, the endless belt according to the embodiment of the present disclosure has the above-described configuration such that the amount of dust attached to the rib member can be reduced.

### Aspects

In the endless belt according to the present disclosure, for example, it is preferable that the inner peripheral surface of the belt substrate and the rib member adhere to each other through an adhesive layer, and that the adhesive layer is conductive.

This way, since the adhesive layer is conductive, the amount of dust attached to the rib member can be reduced.

In the endless belt according to the present disclosure, a volume resistivity of the rib member is, for example, preferably 1×10¹⁰ Log Ω·cm or less and more preferably 1×10⁵ Log Ω·cm or less.

This way, since the volume resistivity of the rib member is 1×10¹⁰ Log Ω·cm or less, the amount of dust attached to the rib member can be reduced.

In the endless belt according to the present disclosure, in a case where a volume resistivity of the belt substrate is represented by ρ1 [Log Ω·cm] and a volume resistivity of the rib member is represented by ρ2 [Log Ω·cm], for example, it is preferable that a relationship of ρ1≥ρ2 is satisfied, and it is more preferable that a relationship of ρ1>ρ2 is satisfied. This way, in the endless belt according to the present disclosure, by satisfying the relationship of ρ1≥ρ2, the amount of dust attached to the rib member can be reduced.

In the endless belt according to the present disclosure, from the viewpoint of further reducing the amount of dust attached to the rib member, for example, an aspect is preferable in which the volume resistivity of the rib member is 1×10⁵ Log Ω·cm or less, the inner peripheral surface of the belt substrate and the rib member adhere to each other through an adhesive layer, and the adhesive layer is conductive.

In the endless belt according to the present disclosure, from the viewpoint of further reducing the amount of dust attached to the rib member, for example, an aspect is preferable in which, in a case where a volume resistivity of the belt substrate is represented by ρ1 [Log Ω·cm] and a volume resistivity of the rib member is represented by ρ2 [Log Ω·cm], a relationship of ρ1>ρ2 is satisfied, and the volume resistivity of the rib member is 1×10⁵ Log Ω·cm or less.

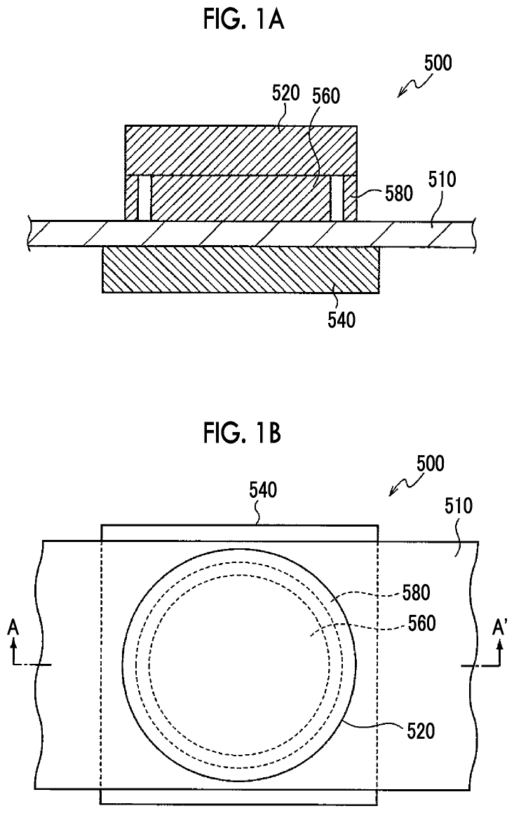

The volume resistivities of the belt substrate and the rib member in the endless belt are measured using a volume resistivity measuring device 500 shown in FIGS. 1A and 1B according to JIS K 6911 or JIS K 6271-1. Specifically, as shown in FIGS. 1A and 1B, the volume resistivity measuring device 500 includes a circular electrode 520 and a flat counter electrode 540. The circular electrode 520 includes: a columnar electrode portion 560; and a cylindrical electrode portion 580 that has an inner diameter more than an outer diameter of the cylindrical electrode portion 560 and surrounds the cylindrical electrode portion 560 with a given gap. The counter electrode 540 is an electrode that is disposed to face the circular electrode 520 through a measurement target (the belt substrate or the rib member) 510.

Examples of the circular electrode 520 include UR PROBE (a probe of a double ring electrode structure) of HIRESTA UP (manufactured by Mitsubishi Chemical Analytech Co., Ltd.). In addition, examples of the counter electrode 540 include a flat electrode formed of SUS 304 (for example, a sheet-like member having a thickness of 5 mm and a size of 80 mm×500 mm). In addition, examples of a current measuring device include a digital ultrahigh resistance/microammeter R8340A (manufactured by Advantest Corporation).

During the measurement of the volume resistivity, for example, an intermediate transfer member 50 that is the endless belt as the measurement target is interposed between the columnar electrode portion 560 in the circular electrode 520 and the counter electrode 540, a weight is placed thereon such that the load reaches 19.6 N, and a uniform load is applied to the measurement target (the belt substrate or the rib member) 510. For example, the digital ultrahigh resistance/microammeter is electrically connected to the circular electrode 520, and measurement conditions are a charge time of 3 sec, a discharge time of 1 sec, and an applied voltage of 500 V. At this time, the measurement is performed in an environment of 20° C.

At this time, it is assumed that the volume resistivity of the measurement target (the belt substrate or the rib member) 510 is represented by ρv, the thickness of the measurement target (the belt substrate or the rib member) 510 is represented by t (m), a read value of the digital ultrahigh resistance/microammeter R8340A is represented by R, and a volume resistivity correction factor of the circular electrode 520 is represented by RCF (V). In a case where UR PROBE of HIRESTA UP (manufactured by Mitsubishi Chemical Analytech Co., Ltd.) is used as the circular electrode 520, RCF (V)=2.011 according to the “Resistivity Meter Series” catalog (manufactured by DIA Instrument Co., Ltd.). Therefore, the volume resistivity of the measurement target is calculated from the following Expression (1).

$$ρ v [ Ω \cdot cm ] = R \times R C F \times ( V ) \times ( 10000 / t ) = R \times 2.011 \times ( 10000 / t ) . \qquad Expression ( 1 )$$

The common logarithmic values of the obtained ρv value are the volume resistivity ρ1 of the belt substrate and the volume resistivity ρ2 of the rib member.

In a case where the rib member is prepared by cutting a commercially available product, the catalog value may be adopted as the volume resistivity ρ2.

The volume resistivity of the adhesive layer may be measured according to JIS K 7194:1994. In addition, in a case where the adhesive is a commercially available product, the catalog value may be adopted as the volume resistivity as in the rib member.

Hereinafter, the endless belt according to the present disclosure will be described in detail with reference to the drawings.

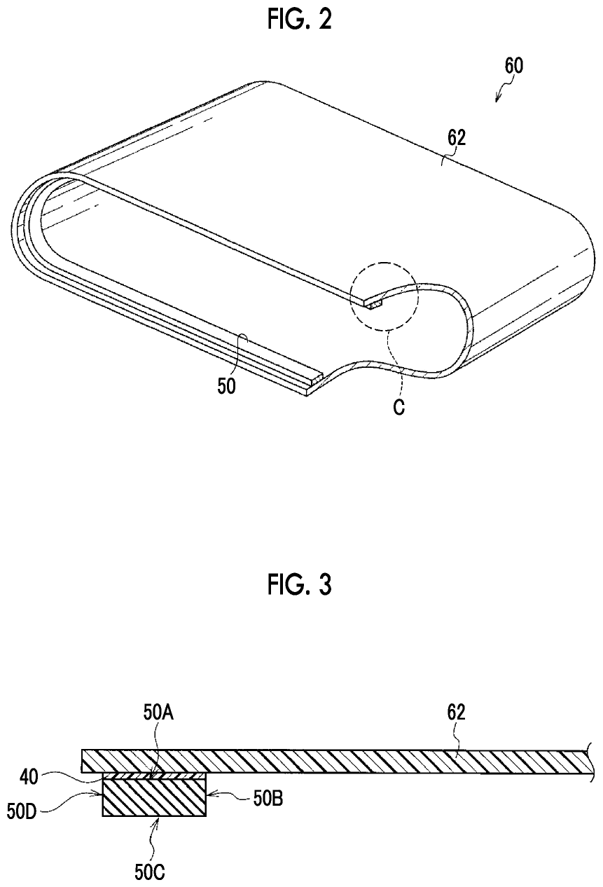

An endless belt 60 shown in FIG. 2 is configured to include: an endless belt substrate 62; and a belt-shaped rib member 50 that is provided in a peripheral direction along at least one end portion in a width direction of an inner peripheral surface of the belt substrate 62.

In addition, as shown in FIG. 3, in the endless belt 60, the inner peripheral surface of the belt substrate 62 and the rib member 50 adhere to each other through an adhesive layer 40. The adhesive layer 40 does not need to be provided as long as the rib member 50 can be fixed to the inner peripheral surface of the belt substrate 62 using another unit (for example, heat fusion).

### Belt Substrate

As long as the belt substrate can be formed in an endless shape, the layer configuration or the like thereof is not particularly limited and may be a configuration corresponding to the use of the endless belt. The belt substrate may have a monolayer structure or a structure in which two or more layers are laminated.

In the present disclosure, it is preferable that the belt substrate includes, for example, a substrate layer and a surface layer.

Here, the surface layer is preferably provided on, for example, an outer peripheral surface of the substrate layer and optionally may be provided on the inner peripheral surface of the substrate layer.

The surface layer provided on the outer peripheral surface of the substrate layer configures the outer peripheral surface of the endless belt. The surface layer provided on the inner peripheral surface of the substrate layer configures the inner peripheral surface of the endless belt.

### Substrate Layer

It is preferable that the substrate layer includes, for example, an elastic material.

Examples of the elastic material include rubber and a resin.

Examples of the rubber include chloroprene rubber, epichlorohydrin rubber, isoprene rubber, butyl rubber, polyurethane, silicone rubber, fluororubber, styrene-butadiene rubber, butadiene rubber, nitrile rubber (NBR), ethylene propylene rubber, ethylene-propylene-diene rubber (EPDM), natural rubber, and a mixed rubber thereof.

Examples of the resin include polyamide, polyimide, polyamide imide, polyether imide, polyether ether ketone, polyphenylene sulfide, polyether sulfone, polyphenyl sulfone, polysulfone, polyethylene terephthalate, polybutylene terephthalate, polyacetal, polycarbonate, polyester, and a mixed resin thereof.

In a case where the endless belt is a transfer belt, from the viewpoints of suppressing image color loss and the formation of color spots, for example, it is preferable that the elastic material includes rubber, and it is more preferable that the elastic material includes chloroprene rubber and ethylene-propylene-diene rubber.

In a case where the elastic material includes chloroprene rubber and ethylene-propylene-diene rubber, a mass ratio (the content of the chloroprene rubber/the content of the ethylene-propylene-diene rubber) of the content of the chloroprene rubber to the content of the ethylene-propylene-diene rubber is, for example, preferably 1 or more and 100 or less, more preferably 3 or more and 50 or less, and still more preferably 5 or more and 20 or less.

It is preferable that the substrate layer includes, for example, conductive particles.

Examples of the conductive particles include carbon black such as Ketjen black, oil furnace black, channel black, or acetylene black; metal particles such as aluminum or nickel; and metal oxide particles such as indium tin oxide, tin oxide, zinc oxide, titanium oxide, or yttrium oxide.

In a case where the endless belt is a transfer belt, from the viewpoints of suppressing image color loss and the formation of color spots, as the conductive particles, for example, carbon black is preferable. The conductive particles may be used alone or in combination of two or more kinds.

The average primary particle diameter of the conductive particles is, for example, preferably 1 nm or more and 150 nm or less, more preferably 3 nm or more and 100 nm or less, and still more preferably 5 nm or more and 50 nm or less.

The content of the conductive particles with respect to the total amount of the elastic material in the substrate layer is, for example, preferably 10 mass % or more and 40 mass % or less, more preferably 10 mass % or more and 35 mass % or less, and still more preferably 15 mass % or more and 30 mass % or less.

The substrate layer may include a conductive agent other than the conductive particles. Examples of the conductive agent include: an ion conductive material such as potassium titanate, potassium chloride, sodium perchlorate, or lithium perchlorate; and an ion conductive polymer such as polyaniline, polyether, polypyrrole, polysulfone, or polyacetylene. The conductive agent may be used alone or in combination of two or more kinds.

The substrate layer may include additives such as an antioxidant, a crosslinking agent, a flame retardant, a colorant, a surfactant, a dispersant, or a filler.

The thickness of the substrate layer is, for example, preferably 400 m or more and 800 m or less, more preferably 420 m or more and 600 m or less, and still more preferably 440 m or more and 500 m or less.

### Surface Layer

It is preferable that the surface layer includes, for example, a resin. Hereinafter, the resin in the surface layer will also be referred to as “surface layer resin”.

It is preferable that the surface layer resin includes, for example, a fluororesin.

Examples of the fluororesin include a tetrafluoroethylene resin, a trifluorochloroethylene resin, a hexafluoropropylene resin, a vinyl fluoride resin, a vinylidene fluoride resin, a difluorodichloro ethylene resin, and a copolymer thereof.

Among these, in a case where the endless belt is a transfer belt, from the viewpoints of suppressing image color loss and the formation of color spots, for example, a tetrafluoroethylene resin (PTFE: polytetrafluoroethylene) is preferable as the fluororesin.

It is preferable that the surface layer resin includes, for example, a urethane resin together with the fluororesin.

The urethane resin (also referred to as polyurethane or urethane rubber) is generally synthesized by polymerizing polyisocyanate and polyol. It is preferable that the urethane resin includes, for example, a hard segment and a soft segment.

The content of the fluororesin, for example, with respect to the total amount of the resin in the surface layer is preferably 10 mass % or more and 35 mass % or less, more preferably 15 mass % or more and 33 mass % or less, and still more preferably 20 mass % or more and 30 mass % or less.

By adjusting the content of the fluororesin to be 10 mass % or more with respect to the total amount of the resin in the surface layer, the content of the fluororesin in the surface layer is an amount in which an action of the surface layer as a dielectric can be further improved.

In addition, by adjusting the content of the fluororesin to be 35 mass % or less with respect to the total amount of the resin in the surface layer, a mechanical strength required for the crack resistance of the surface layer can be ensured.

The surface layer may include additives such as an antioxidant, a crosslinking agent, a flame retardant, a colorant, or a filler.

The thickness of the surface layer is, for example, preferably 1 m or more and 15 m or less, more preferably 2 m or more and 12 m or less, and still more preferably 3 m or more and 10 m or less.

The thickness of the surface layer is measured using an optical microscope. As the optical microscope, for example, a digital microscope VHX (model name, manufactured by Keyence Corporation) can be used.

A measurement procedure of the thickness of the surface layer is as follows. The endless belt is cut in a thickness direction. The obtained cross-section is measured, and the thickness of the surface layer is measured using the image of the optical microscope.

The volume resistivity ρ1 of the belt substrate may be determined depending on the use and is, for example, 1×10⁴ Log Ω·cm or more and 1×10¹² Log Ω·cm or less. In a case where the endless belt according to the present disclosure is a transfer belt, the volume resistivity ρ1 of the belt substrate is, for example, preferably 1×108 Log Ω·cm or more and 1×10¹¹ Log Ω·cm or less.

### Rib Member

The rib member is provided in a peripheral direction along at least one end portion in a width direction of an inner peripheral surface of the belt substrate. A position (distance from a side edge of the belt substrate) where the rib member is provided at the end portion of the belt substrate may be set depending on the use and the function of the endless belt, a device to which the endless belt is applied, and the like. For example, as shown in FIG. 3, an outer side surface of the rib member in the width direction may be provided inside an edge surface of the belt substrate in the width direction or may adhere to be flush with an edge surface of the belt substrate in the width direction.

For example, it is preferable that the rib member is continuously provided over the entire periphery of the inner peripheral surface of the belt substrate. However, a plurality of rib members may be intermittently provided in the peripheral direction of the belt substrate.

In addition, the rib member may be provided at one end portion of the inner peripheral surface of the belt substrate in the width direction, and the rib member may be provided at both end portions of the inner peripheral surface of the belt substrate in the width direction.

It is preferable that the rib member includes, for example, an elastic material and a conductive agent.

Examples of the elastic material include rubber and a resin.

As the elastic material in the rib member, the rubbers and resins described above as the elastic material in the substrate layer can be used.

As the conductive agent in the rib member, the conductive particles and the conductive agents other than the conductive particles described above in the substrate layer are used.

The content of the conductive agent in the rib member may be determined depending on the conductivity of the rib member and is, for example, preferably 4 mass % or more and 50 mass % or less and more preferably 10 mass % or more and 50 mass % or less with respect to the total amount of the elastic material in the rib member.

As the rib member, for example, a conductive urethane sheet (“TR200-90E”, manufactured by Tigers Polymer Corporation, volume resistivity ρ²: 3.8×10⁹ Log Ω·cm), a conductive chloroprene sheet (“NEP-5”, manufactured by Tigers Polymer Corporation, volume resistivity ρ²: 8.6×10⁴ Log Ω·cm), or a conductive chloroprene sheet (“CEP-2”, manufactured by Tigers Polymer Corporation, volume resistivity ρ²: 1.2×10² Log Ω·cm) can be used.

The width (specifically, the distance between a surface 50B and a surface 50D in FIG. 3), the thickness (the distance between a surface 50A and a surface 50C in FIG. 3), and the like of the rib member may be selected depending on the use, usage conditions, and the like of the endless belt.

From the viewpoints of the meandering control effect, the durability, and the like, the width of the rib member is, for example, 1 mm or more and 10 mm or less and more preferably 2 mm or more and 8 mm or less.

In addition, the thickness of the rib member is not particularly limited and, from the viewpoint of the meandering control effect, the durability, and the like, is preferably, 0.5 mm or more and 5 mm or less and more preferably 0.5 mm or more and 3 mm or less.

As shown in FIG. 3, in a case where the rib member 50 is cut in the axis direction of the belt, a cross-sectional shape is a rectangular shape. However, the cross-sectional shape is not particularly limited to the rectangular shape and may be appropriately selected depending on the shape, the disposition, and the like of support rollers in contact with the rib member 50. In a case where the rib member is cut in the axis direction of the belt, the cross-sectional shape may be, for example, a polygonal shape other than a quadrangular shape or may be a shape having a curved surface such as a circular shape or an elliptical shape.

### Adhesive Layer

As the adhesive layer, for example, a well-known adhesive or an adhesive sheet can be applied. Specifically, for example, an elastic adhesive or a heat-sensitive adhesive sheet can be used.

Examples of the elastic adhesive include “SUPER-X No. 8008” (manufactured by CEMEDINE Co., Ltd.) including an acrylic modified silicone polymer as a major component, a conductive adhesive “SX-ECA48” (manufactured by CEMEDINE Co., Ltd.) including an acrylic modified special polymer as a major component, and “SILEX 100” (manufactured by Konishi Co., Ltd.) including a special modified silicone polymer as a major component. For example, from the viewpoint of an adhesion strength with the belt substrate, “SUPER-X No. 8008” (manufactured by CEMEDINE Co., Ltd.) including an acrylic modified silicone polymer as a major component is more preferably used. From the viewpoint of obtaining the conductive adhesive layer, for example, a conductive adhesive “SX-ECA48” (manufactured by CEMEDINE Co., Ltd.) including an acrylic modified special polymer as a major component is more preferably used.

The heat-sensitive adhesive sheet is not particularly limited as long as it has excellent adhesiveness between the belt substrate and the rib member. For example, an adhesive sheet including, as a major material, a resin material, for example, an acrylic resin, a silicone resin, a natural or synthetic rubber, a urethane resin, or a synthetic resin such as a vinyl chloride-vinyl acetate copolymer can be used.

Specific examples of the adhesive sheet include polyester adhesive sheets GM-913 and GM-920 (manufactured by Toyobo Co., Ltd.) and a polyester adhesive sheet D3600 (manufactured by Sony Chemicals Corporation). For example, from the viewpoint of an adhesion strength with the belt substrate 62, a polyester adhesive sheet D3600 (manufactured by Sony Chemicals Corporation) or a polyester adhesive sheet GM-920 (manufactured by Toyobo Co., Ltd.) is preferably used.

The thickness of the adhesive layer is, for example, preferably 0.01 mm or more and 0.3 mm or less and more preferably 0.02 mm or more and 0.05 mm or less. In a case where the thickness of the adhesive layer is 0.01 mm or more, a highly uniform adhesion strength is likely to be obtained, and in a case where the thickness of the adhesive layer is 0.3 mm or less, positional displacement of the rib member caused by adhesion unevenness is suppressed.

### Method of Manufacturing Endless Belt

Examples of a method of manufacturing the endless belt according to the present disclosure include a method including: preparing a tubular member as the substrate layer; forming the surface layer on at least one of the outer peripheral surface or the inner peripheral surface of the tubular member to obtain the belt substrate; and adhering the rib member to an intended position of the obtained belt substrate.

Examples of a method of manufacturing the tubular member as the substrate layer include: extrusion molding in which a composition including an elastic material and conductive particles is melted and extruded into a belt shape from a die and then solidified; injection molding in which a composition including an elastic material and conductive particles is melted and put into a belt-shaped mold and then solidified; and application molding in which a composition including a precursor or a monomer of an elastic material and conductive particles is applied to a core and solidified.

Examples of a method of forming the surface layer include: a method in which a liquid composition that includes a resin including a fluororesin is applied to at least one of an outer peripheral surface or an inner peripheral surface of the tubular member and solidified; and a method in which a liquid composition including a precursor or a monomer of the surface layer resin other than a fluororesin and a fluororesin is applied to an outer peripheral surface or an inner peripheral surface of the tubular member and solidified. In order to solidify the liquid composition, drying, heating, electron beam irradiation, or ultraviolet irradiation may be performed depending on the kinds of the components.

Examples of the adhesion of the rib member include a method of applying an adhesive or bonding an adhesive sheet to a surface of the rib member for adhesion to the belt substrate (the adhesion surface 50A in FIG. 3) to adhere the rib member to the belt substrate.

### Transfer Unit

A transfer unit according to the present disclosure includes: the endless belt according to the exemplary embodiment; and a plurality of rollers that include at least one roller coming into contact with the rib member of the endless belt to suppress movement in a width direction of the endless belt and rotatably support the endless belt.

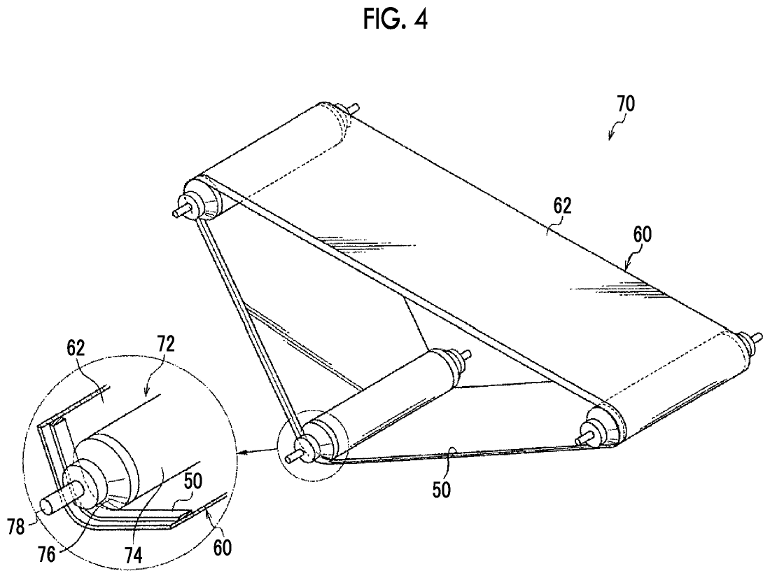

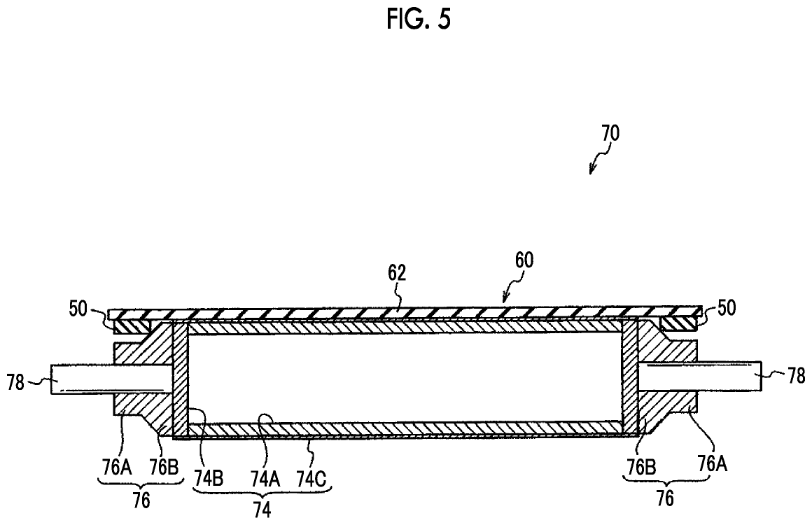

FIG. 4 is a schematic configuration diagram showing an example of a configuration of the transfer unit according to the present disclosure. FIG. 5 is a partial cross-sectional view showing an example of the configuration of the transfer unit according to the present disclosure. In a transfer unit 70 shown in FIG. 5, the rib member 50 is provided on the inner peripheral surface side at both end portions of the belt substrate 62.

The transfer unit 70 includes: the endless belt 60 according to the present disclosure; and a guide-equipped support roller 72 that is provided in contact with the inner peripheral surface of the endless belt 60 and rotatably supports the endless belt 60. In the guide-equipped support roller 72, a meandering control member guide 76 (regulating member) that comes into contact with the rib member 50 of the endless belt 60 to suppress movement in the width direction of the endless belt 60 is provided. The transfer unit shown in FIG. 4 includes three guide-equipped support rollers 72. However, the number of the guide-equipped support rollers 72 is not particularly limited as long as the transfer unit includes one or more support rollers 72 at least one of which is the guide-equipped support roller.

The guide-equipped support roller 72 includes: a support roller main body 74 that is in contact with the inner peripheral surface of the endless belt 60; the meandering control member guide 76 (regulating member) that is provided at both end portions of the support roller main body 74 in the axis direction; and a shaft 78 that is connected to a center portion of both edge surfaces of the support roller main body 74 in the axis direction and penetrates the meandering control member guide 76 to extend to the outer side in the axis direction.

The support roller main body 74 has a function of coming into contact with the inner peripheral surface of the endless belt 60 together with another support roller to hold the endless belt 60 while applying a tension thereto. The support roller main body 74 is configured by: a cylindrical body 74A having an opening at both edges in the axis direction; and a lid body 74B that blocks the opening. Examples of a constituent material of the support roller main body 74 include aluminum.

On an outer peripheral surface of the support roller main body 74, a high friction material layer 74C is provided in order to prevent the belt from slipping in a case where a load is applied to the belt substrate. As the high friction material layer 74C, for example, a polyurethane coating layer (5 μm or more and 50 μm or less, for example, preferably about 25 μm) is applied.

The meandering control member guide 76 is a member that comes into contact with the rib member 50 to regulate movement in the width direction of the endless belt 60. The meandering control member guide 76 includes, for example, a small diameter portion 76A and a large diameter portion 76B that is provided on the support roller main body 74 side with respect to the small diameter portion 76A. A truncated cone shape is formed between the small diameter portion 76A and the large diameter portion 76B such that the small diameter portion 76A and the large diameter portion 76B are integrally formed and are coaxially connected to each other. The meandering control member guide 76 is provided on the same axis as the support roller main body 74 in a state where the shaft 78 penetrates the meandering control member guide 76. A constituent material of the meandering control member guide 76 is not particularly limited, and a resin material that has a smooth surface and has excellent sliding properties is preferably used. For example, polyacetal is used.

In the present exemplary embodiment, as shown in FIG. 5, the inner side surface 50B of the rib member 50 and an edge portion where the inner side surface 50B and the surface 50C opposite to the adhesion surface 50A intersect with each other come into contact with the truncated conical portion where the small diameter portion 76A and the large diameter portion 76B of the meandering control member guide 76 are connected. As a result, the movement in the axis direction of the endless belt 60 is regulated. The rib member 50 in the endless belt according to the present disclosure is conductive. As a result, as shown in FIG. 5, even in a case where the rib member 50 comes into contact with the meandering control member guide 76, frictional charging of the rib member 50 is suppressed, and dust is suppressed from being attached to the rib member 50.

In the configuration shown in FIG. 5, The meandering control member guide 76 is disposed on both end portion sides in the axis direction of the support roller main body 74. However, in a case where the rib member 50 is provided only at a single end portion in the axis direction of the belt substrate 62, the meandering control member guide 76 may be provided on an end portion side where the rib member 50 of the endless belt 60 is provided among both end portions in the axis direction of the support roller main body 74.

The guide-equipped support roller 72 is disposed in the transfer unit, for example, as a tension roller, a steering roller, an idle roller, a drive roller, or a backup roller. This roller is provided depending on the use. In the transfer unit according to the present disclosure, a plurality of support rollers are disposed, for example, as shown in FIG. 4. However, all of the rollers do not need to be the guide-equipped support rollers having the above-described configuration, and at least one of the support rollers only needs to include the meandering control member guide 76.

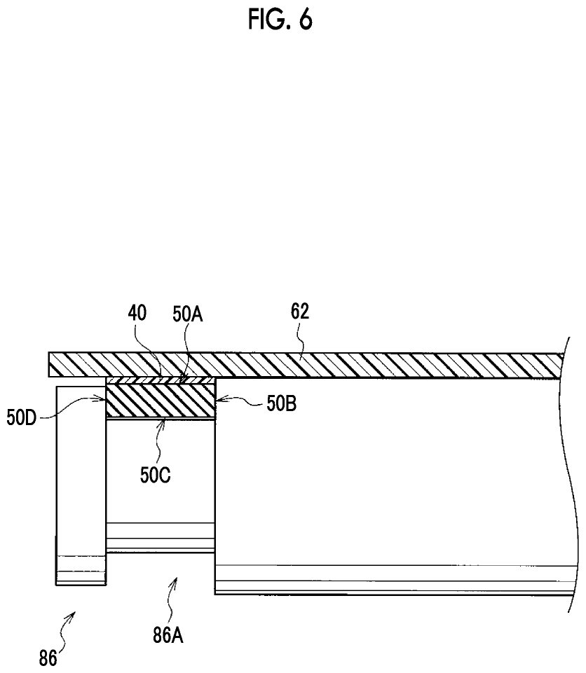

In addition, the meandering control member guide 76 is not limited to the above-described configuration. For example, the meandering control member guide 76 may be configured with a columnar or cylindrical member where a groove or a notch into which the rib member 50 is inserted is provided in a peripheral direction. For example, as shown in FIG. 6, a meandering control member guide 86 where a groove portion 86A into which the rib member 50 is inserted may be adopted. In a case where the rib member 50 is inserted into the groove portion 86A of the meandering control member guide 86, the inner side surface 50B and the outer side surface 50D of the rib member 50 come into contact with an inner wall of the groove portion 86A of the meandering control member guide 86. In this case, the rib member 50 is conductive such that, as shown in FIG. 6, even in a case where the rib member 50 comes into contact with the groove portion 86A of the meandering control member guide 86, frictional charging of the rib member 50 is suppressed and dust is suppressed from being attached to the rib member 50.

### Image Forming Apparatus

Next, an image forming apparatus according to the present disclosure will be described.

The image forming apparatus according to the present disclosure is configured to include: an electrophotographic photoreceptor; a charging section that charges a surface of the electrophotographic photoreceptor; an electrostatic latent image forming section that forms an electrostatic latent image on the charged surface of the electrophotographic photoreceptor; a developing section that develops the electrostatic latent image formed on the surface of the electrophotographic photoreceptor with a developer containing a toner to form a toner image; and a transfer section that includes the transfer unit according to the present disclosure and transfers the toner image formed on the surface of the electrophotographic photoreceptor to a surface of a recording medium through the endless belt.

It is preferable that the image forming apparatus according to the present disclosure is, for example, a high-speed apparatus in which a process speed is 180 mm/s or higher. Even in the high-speed apparatus, the endless belt according to the present disclosure that is applied as the transfer belt of the image forming apparatus according to the present disclosure can effectively suppress the frictional charging of the rib member. Therefore, the amount of dust attached to the rib member can be reduced. In addition, as a result, the occurrence of transfer failure caused by the attachment of dust to the rib member can be suppressed.

The image forming apparatus according to the present disclosure may be, for example, a monochrome image forming apparatus that contains only a monochromatic toner in a developing device or a color image forming apparatus including a plurality of developing devices having different color toners, in which toner images having different colors formed on surfaces of the electrophotographic photoreceptors are sequentially primarily transferred to the belt substrate as an intermediate transfer member and are superimposed to form a color image.

Hereinafter, as an example of the image forming apparatus according to the present disclosure, an image forming apparatus in which toner images having different colors are superimposed to form a color image will be described.

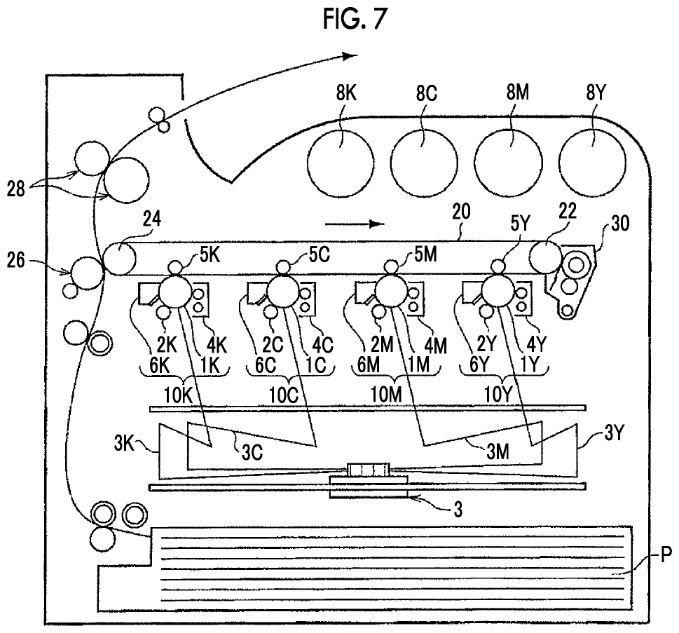

FIG. 7 schematically shows a configuration of an example of the image forming apparatus according to the present disclosure. The image forming apparatus illustrated in FIG. 7 includes first to fourth electrophotographic image forming units 10Y, 10M, 10C, and 10K that output images of colors of yellow (Y), magenta (M), cyan (C), and black (K) based on color-separated pieces of image data. These image forming units (hereinafter, simply referred to as “units”) 10Y, 10M, 10C, and 10K are arranged in parallel at specific distances in the horizontal direction. The units 10Y, 10M, 10C, and 10K may be process cartridges that are detachable from the image forming apparatus main body.

An intermediate transfer belt 20 formed of the endless belt according to the present disclosure as an intermediate transfer member passes through and is disposed above the units 10Y, 10M, 10C, and 10K in the drawing. The intermediate transfer belt 20 is provided to be wound around a drive roller 22 and a support roller 24 that is in contact with an inner surface of the intermediate transfer belt 20, the rollers 22 and 24 being disposed to be spaced from each other in a direction from the left to the right in FIG. 7. The intermediate transfer belt 20 is configured to travel (rotate) the transfer unit for an image forming apparatus in a direction toward the fourth unit 10K from the first unit 10Y.

In each of the drive roller 22 and the support roller 24, the meandering control member guide 76 is provided.

In addition, the support roller 24 is biased in a direction distant from the drive roller 22 using a spring (not shown), and a specific tension is applied to the intermediate transfer belt 20 wound around the drive roller 22 and the support roller 24. An intermediate transfer member cleaning device 30 is provided to face the drive roller 22 on an image holder side surface of the intermediate transfer belt 20.

In addition, toners of four colors including yellow, magenta, cyan, and black contained in toner cartridges 8Y, 8M, 8C, and 8K are supplied to developing devices (developing sections) 4Y, 4M, 4C, and 4K of the units 10Y, 10M, 10C, and 10K, respectively.

The first to fourth units 10Y, 10M, 10C, and 10K have the same configuration. Therefore, here, the first unit 10Y that is disposed upstream of the intermediate transfer belt in the traveling direction and forms a yellow image will be representatively described. The same components in the first unit 10Y are represented by reference numerals with magenta (M), cyan (C), and black (K) instead of yellow (Y), and the description of the second to fourth units 10M, 10C, and 10K will not be repeated.

The first unit 10Y includes a photoreceptor 1Y that acts as an image holder. In the vicinity of the photoreceptor 1Y, a charging roller 2Y that charges a surface of the photoreceptor 1Y to a specific potential, an exposure device 3 that exposes the charged surface based on a color-separated image signal to a laser beam 3Y to form an electrostatic charge image, a developing device (developing section) 4Y that supplies the charged toner to the electrostatic charge image to develop the electrostatic charge image, a primary transfer roller 5Y (primary transfer section) that transfers the developed toner image to the intermediate transfer belt 20, and a photoreceptor cleaning device (cleaning section) 6Y that removes toner remaining on the surface of the photoreceptor 1Y after the primary transfer using a cleaning blade are sequentially provided.

The primary transfer roller 5Y is disposed inside of the intermediate transfer belt 20 and is provided at a position facing the photoreceptor 1Y. Further, a bias power supply (not shown) that applies a primary transfer bias is connected to each of the primary transfer rollers 5Y, 5M, 5C, and 5K. Each of the bias power supplies changes the transfer bias applied to each of the primary transfer rollers under the control of a controller (not shown). The meandering control member guide 76 is also provided in each of the primary transfer rollers 5Y, 5M, 5C, and 5K.

Hereinafter, the operation of forming form a yellow image in the first unit 10Y will be described. First, before the operation, the surface of the photoreceptor 1Y is charged to about a potential of −600 V or higher and −800 V or lower by the charging roller 2Y. The photoreceptor 1Y is formed by laminating a photosensitive layer on a conductive (for example, volume resistivity at 20° C.: 1×10⁶ Ωcm or less) substrate. The photosensitive layer typically has a high resistance (about a resistance of a general resin) but has a property in which, in a case where the photosensitive layer is irradiated with the laser beam 3Y, a specific resistance of the portion irradiated with the laser beam changes. Accordingly, the laser beam 3Y is output to the charged surface of the photoreceptor 1Y through the exposure device 3 based on yellow image data transmitted from the controller (not shown). The photosensitive layer of the surface of the photoreceptor 1Y is irradiated with the laser beam 3Y such that an electrostatic charge image of a yellow printing pattern is formed on the surface of the photoreceptor 1Y.

The electrostatic charge image is an image formed on the surface of the photoreceptor 1Y by charging and is a so-called negative latent image formed in a manner in which the specific resistance of the portion of the photosensitive layer irradiated with the laser beam 3Y decreases, charges flow through the charged surface of the photoreceptor 1Y, and charges remain in a portion not irradiated with the laser beam 3Y.

This way, the electrostatic charge image formed on the photoreceptor 1Y is rotated to a specific development position as the photoreceptor 1Y travels. At the development position, the electrostatic charge image on the photoreceptor 1Y is developed to form a visible image (developed image) by the developing device 4Y.

The developing device 4Y contains, for example, yellow toner. By being agitated in the developing device 4Y, the yellow toner is frictionally charged to have charges having the same polarity (negative) as the charges on the photoreceptor 1Y and is held by a developer roller (developer holder). Then, as the surface of the photoreceptor 1Y passes through the developing device 4Y, the yellow toner is electrostatically attached to a neutralized latent image portion on the surface of the photoreceptor 1Y, and a latent image is developed by the yellow toner. The photoreceptor 1Y on which the yellow toner image is formed travels at a specific speed, and the developed toner image on the photoreceptor 1Y is transported to a specific primary transfer position.

In a case where the yellow toner image on the photoreceptor 1Y is transported to the primary transfer position, a specific primary transfer bias is applied to the primary transfer roller 5Y, an electrostatic force from the photoreceptor 1Y toward the primary transfer roller 5Y acts on the toner image, and the toner image on the photoreceptor 1Y is transferred to the intermediate transfer belt 20. The transfer bias applied at this time has a polarity (+) opposite to the polarity (−) of the toner. For example, in the first unit 10Y, the transfer bias is controlled to about +10 μA by the controller (not shown).

On the other hand, the toner remaining on the photoreceptor 1Y is removed by a cleaning device 6Y and collected.

In addition, the primary transfer biases applied to the primary transfer rollers 5M, 5C, and 5K in and after the second unit 10M are also controlled according to the first unit.

This way, the intermediate transfer belt 20 to which the yellow toner image is transferred by the first unit 10Y is sequentially transported through the second to fourth units 10M, 10C, and 10K, and the multiple toner images of the respective colors are superimposed and transferred thereto.

The intermediate transfer belt 20, to which the four color multiple toner images are transferred through the first to fourth units reaches a secondary transfer portion that is configured by the intermediate transfer belt 20, the support roller 24 in contact with the inner surface of the intermediate transfer belt 20, and a secondary transfer roller 26 (secondary transfer section) disposed on an image holding surface side of the intermediate transfer belt 20. On the other hand, a recording medium P is fed to a gap in contact with the secondary transfer roller 26 and the intermediate transfer belt 20 through a supply mechanism, and a specific secondary transfer bias is applied to the support roller 24. The transfer bias applied at this time has the same polarity (−) as the polarity (−) of the toner, an electrostatic force from the intermediate transfer belt 20 toward the recording medium P acts on the toner image, and the toner image on the intermediate transfer belt 20 is transferred to the recording medium P. The secondary transfer bias at this time is determined according to the resistance detected by a resistance detection section (not shown) that detects the resistance of the secondary transfer portion, and the voltage thereof is controlled.

Next, the recording medium P is transported to a fixing device (fixing section) 28, the superimposed color toner images are heated and fused, and the toner image is fixed to the recording medium P. The recording medium P on which the fixing of the color image is completed is transported to a discharge portion, and a series of color image forming operations end.

The image forming apparatus described as the example has the configuration in which a plurality of toner images are superimposed and transferred to the recording medium P through the intermediate transfer belt 20. The image forming apparatus according to the present disclosure is not limited to the above-described configuration. For example, the image forming apparatus according to the exemplary embodiment of the present disclosure may be an image forming apparatus in which a monochromatic toner image formed on the surface of the photoreceptor is transferred to a recording medium through the intermediate transfer belt 20.

### EXAMPLES

Hereinafter, the present invention will be described using examples, but the present invention is not limited to these examples.

### Preparation of Endless Belt

An endless belt according to each of examples is obtained as follows.

### Example 1

### Preparation of Substrate Layer

85 parts of a mixture of chloroprene rubber as an elastic material and carbon black as conductive particles (the content of the carbon black with respect to the total amount of the mixture is 25 mass %) and 15 parts of ethylene-propylene-diene rubber as an elastic material are mixed to obtain a composition, and the obtained composition is extruded using a kneading extruder to obtain a molded product. The molded product is dried with hot air to obtain a tubular member having a diameter (outer diameter) of 40 mm and a thickness of 450 m. The tubular member is cut to a length of 355 mm to obtain a substrate layer.

### Preparation of Surface Layer

By adding 1 mass % of a curing agent (LOCTITE WH-1, manufactured by Henkel Japan Ltd.) to a urethane resin (BONDERITE T862A, manufactured by Henkel Japan Ltd.) including a tetrafluoroethylene resin as a fluororesin and diluting the mixture with water, a coating liquid is prepared (the content of the tetrafluoroethylene resin is 20 mass % with respect to the total amount of the coating liquid).

In a state where the central axis of the substrate layer is in the horizontal direction, the coating liquid is sprayed to the outer peripheral surface of the substrate layer while rotating the substrate layer. Next, the coating film is dried with hot air at 150° C. for 35 minutes to form a surface layer on the outer peripheral surface of the substrate layer.

Using the same method as described above, the coating liquid is also sprayed to the inner peripheral surface of the substrate layer, and the coating liquid is dried with hot air under the same conditions to form a surface layer on the inner peripheral surface of the substrate layer.

Both of the thicknesses of the surface layers formed on the outer peripheral surface and the inner peripheral surface of the substrate layer are 6 m.

Through the above-described procedure, a belt substrate 1 is obtained. The volume resistivity of the belt substrate 1 is 3.2×10¹⁰ Log Ω·cm.

### Adhesion of Rib Member

A conductive urethane sheet (“TR200-90E”, manufactured by Tigers Polymer Corporation) having a volume resistivity of 3.8×10⁹ [Log Ω·cm] is cut into a strip shape having a thickness of 1.0 mm, a width of 5.0 mm, and a length of 122.5 mm to obtain a rib member 1. “SUPER-X No. 8008” (manufactured by CEMEDINE Co., Ltd.) as an adhesive 1 is applied to the two strip-shaped rib members 1, the coating surface of the adhesive is pressed with both end portions of the inner peripheral surface of the belt substrate 1, and the rib member 1 adheres to the belt substrate 1.

The volume resistivity of “SUPER-X No. 8008” (manufactured by CEMEDINE Co., Ltd.) is 5.7×10¹⁴ Log Ω·cm, and thus “SUPER-X No. 8008” is not conductive. This way, an endless belt 1 is obtained.

### Example 2

An endless belt 2 is obtained using the same method as the method of Example 1, except that an adhesive 2 (“SX-ECA48” manufactured by CEMEDINE Co., Ltd. having a volume resistivity of 4.9×10³ Log Ω·cm) is used instead of the adhesive 1.

### Example 3

An endless belt 3 is obtained using the same method as the method of Example 2, except that a rib member 2 is obtained and used by using a conductive chloroprene sheet (“NEP-5” manufactured by Tigers Polymer Corporation) having a volume resistivity of 8.6×10⁴ Log Ω·cm instead of the conductive urethane sheet used as the rib member 1.

### Example 4

An endless belt 4 is obtained using the same method as the method of Example 2, except that a rib member 3 is obtained and used by using a conductive chloroprene sheet (“CEP-2” manufactured by Tigers Polymer Corporation) having a volume resistivity of 1.2×10² Log Ω·cm instead of the conductive urethane sheet used as the rib member 1.

### Example 5

By using the composition for forming the substrate layer used in Example 1 and using the same method as the method of forming the substrate layer according to Example 1, a sheet-like molded product having a thickness of 1 mm, a width of 40 mm, and a length of 130 mm is prepared. The obtained sheet-like molded product is cut into a strip shape having a thickness of 1.0 mm, a width of 5.0 mm, and a length of 122.5 mm to obtain a rib member 4 (volume resistivity: 3.2×10¹⁰ Log Ω·cm).

An endless belt 5 is obtained using the same method as the method of Example 2, except that the obtained rib member 4 is used instead of a conductive urethane sheet formed of the rib member 1.

### Example 6

A rib member 5 (volume resistivity: 6.6×10¹⁰ Log Ω·cm) is obtained using the same method as the method of Example 5, except that the content of the carbon black in the composition for forming the substrate layer used in Example 1 is changed to 20 mass %. An endless belt 6 is obtained using the same method as the method of Example 2, except that the obtained rib member 5 is used instead of a conductive urethane sheet formed of the rib member 1.

### Example 7

A belt substrate 2 (volume resistivity: 2.7×10¹⁰ Log Ω·cm) is obtained using the same method as the method of Example 1, except that the content of the carbon black in the composition for forming the substrate layer is changed to 35 mass %.

An endless belt 7 is obtained using the same method as the method of Example 2, except that the obtained belt substrate 2 is used instead of the belt substrate 1.

### Comparative Example 1

An endless belt 8 is obtained using the same method as the method of Example 1, except that a rib member 6 is obtained and used by using an insulating urethane sheet (“TR200-90” manufactured by Tigers Polymer Corporation) having a volume resistivity of 5.5×10¹³ Log Ω·cm instead of the conductive urethane sheet used as the rib member 1.

### Evaluation

The endless belt obtained in each of the examples is attached to ApeosPro C810 (manufactured by FUJIFILM Business Innovation Corp.) as a secondary transfer belt, a solid image having a density of 25% of each of the colors YMCK is printed on 100,000 sheets of A4 in an environment of 10° C. and 15%, and the attachment of dust such as toner to the rib member of the endless belt is observed by visual inspection and is evaluated based on the following standards.

During printing the images, the process speed is 364 mm/s.

### Evaluation Standard

G1: substantially no attachment of dust in the rib member is observed.
G2: attachment of dust is very slightly observed in the rib member.
G3: attachment of dust is slightly observed in the rib member.
G4: attachment of dust is observed in the rib member but a lump is not formed (allowable level).
G5: a lump of dust (a lump having a diameter of 500 m or more) is observed.

TABLE 1

| | | | | | | Adhesive | | |
|---|---|---|---|---|---|---|---|---|
| | | Belt Substrate | | Rib Member | | (Adhesive Layer) | | Evaluation |
| | Endless | | Volume | | Volume | | Volume | of Amount |
| | Belt | | Resistivity ρ1 | | Resistivity ρ2 | | Resistivity | of Dust |
| | No. | Kind | [LogΩ · cm] | Kind | [LogΩ · cm] | Kind | [LogΩ · cm] | Attached |
| Example 1 | 1 | 1 | 3.2 × 10¹⁰ | 1 | 3.8 × 10⁹ | 1 | 5.7 × 10¹⁴ | G3 |
| Example 2 | 2 | 1 | 3.2 × 10¹⁰ | 1 | 3.8 × 10⁹ | 2 | 4.9 × 10⁻³ | G2 |
| Example 3 | 3 | 1 | 3.2 × 10¹⁰ | 2 | 8.6 × 10⁴ | 2 | 4.9 × 10⁻³ | G1 |
| Example 4 | 4 | 1 | 3.2 × 10¹⁰ | 3 | 1.2 × 10² | 2 | 4.9 × 10⁻³ | G1 |
| Example 5 | 5 | 1 | 3.2 × 10¹⁰ | 4 | 3.2 × 10¹⁰ | 2 | 4.9 × 10⁻³ | G4 |
| Example 6 | 6 | 1 | 3.2 × 10¹⁰ | 5 | 6.6 × 10¹⁰ | 2 | 4.9 × 10⁻³ | G4 |
| Example 7 | 7 | 2 | 2.7 × 10⁹ | 1 | 3.8 × 10⁹ | 2 | 4.9 × 10⁻³ | G2 |
| Comparative | 8 | 1 | 3.2 × 10¹⁰ | 6 | 5.5 × 10¹³ | 1 | 5.7 × 10¹⁴ | G5 |
| Example 1 | | | | | | | | |

Hereinafter, aspects of the present invention will be additionally described.

(((1)))

An endless belt comprising:
an endless belt substrate; and
a belt-shaped rib member that is provided in a peripheral direction along at least one end portion in a width direction of an inner peripheral surface of the belt substrate,
wherein the rib member is conductive.
   (((2)))

The endless belt according to (((1))),
wherein the inner peripheral surface of the belt substrate and the rib member adhere to each other through an adhesive layer, and
the adhesive layer is conductive.
   (((3)))

The endless belt according to (((1))) or (((2))),
wherein a volume resistivity of the rib member is 1×10¹⁰ Log Ω·cm or less.
   (((4)))

The endless belt according to (((3))),
wherein the volume resistivity of the rib member is 1×10⁵ Log Ω·cm or less.
   (((5)))

The endless belt according to any one of (((1))) to (((4))),
wherein in a case where a volume resistivity of the belt substrate is represented by ρ1 [Log Ω·cm] and a volume resistivity of the rib member is represented by ρ2 [Log Ω·cm], a relationship of ρ1≥ρ2 is satisfied.
   (((6)))

The endless belt according to (((5))),
wherein in a case where the volume resistivity of the belt substrate is represented by ρ1 [Log Ω·cm] and the volume resistivity of the rib member is represented by ρ2 [Log Ω·cm], a relationship of ρ1≥ρ2 is satisfied.
   (((7)))

The endless belt according to any one of (((1))) to (((6))),
wherein a volume resistivity of the rib member is 1×10⁵ Log Ω·cm or less, the inner peripheral surface of the belt substrate and the rib member adhere to each other through an adhesive layer, and
the adhesive layer is conductive.
   (((8)))

The endless belt according to any one of (((1))) to (((6))),
wherein in a case where a volume resistivity of the belt substrate is represented by ρ1 [Log Ω·cm] and a volume resistivity of the rib member is represented by ρ2 [Log Ω·cm], a relationship of ρ1>ρ2 is satisfied, and
the volume resistivity of the rib member is 1×10⁵ Log Ω·cm or less.

(((9)))

A transfer unit comprising:
the endless belt according to any one of (((1))) to (((8))); and
a plurality of rollers that include at least one roller coming into contact with the rib member of the endless belt to suppress movement in a width direction of the endless belt and rotatably support the endless belt.
   (((10)))

An image forming apparatus comprising:
an electrophotographic photoreceptor;
a charging section that charges a surface of the electrophotographic photoreceptor;
an electrostatic latent image forming section that forms an electrostatic latent image on the charged surface of the electrophotographic photoreceptor;
a developing section that develops the electrostatic latent image formed on the surface of the electrophotographic photoreceptor with a developer containing a toner to form a toner image; and
a transfer section that includes the transfer unit according to (((9))) and transfers the toner image formed on the surface of the electrophotographic photoreceptor to a surface of a recording medium through the endless belt.
   (((11)))

The image forming apparatus according to (((10))),
wherein a process speed is 180 mm/s or higher.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An endless belt comprising:
an endless belt substrate; and
a belt-shaped rib member that is provided in a peripheral direction along at least one end portion in a width direction of an inner peripheral surface of the belt substrate,
wherein the rib member is conductive.

2. The endless belt according to claim 1,
wherein the inner peripheral surface of the belt substrate and the rib member adhere to each other through an adhesive layer, and
the adhesive layer is conductive.

3. The endless belt according to claim 1,
wherein a volume resistivity of the rib member is 1×10¹⁰ Log Ω·cm or less.

4. The endless belt according to claim 3,
wherein the volume resistivity of the rib member is 1×10⁵ Log Ω·cm or less.

5. The endless belt according to claim 1,
wherein in a case where a volume resistivity of the belt substrate is represented by ρ1 [Log Ω·cm] and a volume resistivity of the rib member is represented by ρ2 [Log Ω·cm], a relationship of ρ1≥ρ2 is satisfied.

6. The endless belt according to claim 5,
wherein in a case where the volume resistivity of the belt substrate is represented by ρ1 [Log Ω·cm] and the volume resistivity of the rib member is represented by ρ2 [Log Ω·cm], a relationship of ρ1≥ρ2 is satisfied.

7. The endless belt according to claim 1,
wherein a volume resistivity of the rib member is 1×10⁵ Log Ω·cm or less,
the inner peripheral surface of the belt substrate and the rib member adhere to each other through an adhesive layer, and
the adhesive layer is conductive.

8. The endless belt according to claim 1,
wherein in a case where a volume resistivity of the belt substrate is represented by ρ1 [Log Ω·cm] and a volume resistivity of the rib member is represented by ρ2 [Log Ω·cm], a relationship of ρ1>ρ2 is satisfied, and
the volume resistivity of the rib member is 1×10⁵ Log Ω·cm or less.

9. A transfer unit comprising:
the endless belt according to claim 1; and
a plurality of rollers that include at least one roller coming into contact with the rib member of the endless belt to suppress movement in a width direction of the endless belt and rotatably support the endless belt.

10. A transfer unit comprising:
the endless belt according to claim 2; and
a plurality of rollers that include at least one roller coming into contact with the rib member of the endless belt to suppress movement in a width direction of the endless belt and rotatably support the endless belt.

11. A transfer unit comprising:
the endless belt according to claim 3; and
a plurality of rollers that include at least one roller coming into contact with the rib member of the endless belt to suppress movement in a width direction of the endless belt and rotatably support the endless belt.

12. A transfer unit comprising:
the endless belt according to claim 4; and
a plurality of rollers that include at least one roller coming into contact with the rib member of the endless belt to suppress movement in a width direction of the endless belt and rotatably support the endless belt.

13. A transfer unit comprising:
the endless belt according to claim 5; and
a plurality of rollers that include at least one roller coming into contact with the rib member of the endless belt to suppress movement in a width direction of the endless belt and rotatably support the endless belt.

14. A transfer unit comprising:
the endless belt according to claim 6; and
a plurality of rollers that include at least one roller coming into contact with the rib member of the endless belt to suppress movement in a width direction of the endless belt and rotatably support the endless belt.

15. A transfer unit comprising:
the endless belt according to claim 7; and
a plurality of rollers that include at least one roller coming into contact with the rib member of the endless belt to suppress movement in a width direction of the endless belt and rotatably support the endless belt.

16. A transfer unit comprising:
the endless belt according to claim 8; and
a plurality of rollers that include at least one roller coming into contact with the rib member of the endless belt to suppress movement in a width direction of the endless belt and rotatably support the endless belt.

17. An image forming apparatus comprising:
an electrophotographic photoreceptor;
a charging section that charges a surface of the electrophotographic photoreceptor;
an electrostatic latent image forming section that forms an electrostatic latent image on the charged surface of the electrophotographic photoreceptor;
a developing section that develops the electrostatic latent image formed on the surface of the electrophotographic photoreceptor with a developer containing a toner to form a toner image; and
a transfer section that includes the transfer unit according to claim 9 and transfers the toner image formed on the surface of the electrophotographic photoreceptor to a surface of a recording medium through the endless belt.

18. An image forming apparatus comprising:
an electrophotographic photoreceptor;
a charging section that charges a surface of the electrophotographic photoreceptor;
an electrostatic latent image forming section that forms an electrostatic latent image on the charged surface of the electrophotographic photoreceptor;
a developing section that develops the electrostatic latent image formed on the surface of the electrophotographic photoreceptor with a developer containing a toner to form a toner image; and
a transfer section that includes the transfer unit according to claim 10 and transfers the toner image formed on the surface of the electrophotographic photoreceptor to a surface of a recording medium through the endless belt.

19. An image forming apparatus comprising:
an electrophotographic photoreceptor;
a charging section that charges a surface of the electrophotographic photoreceptor;
an electrostatic latent image forming section that forms an electrostatic latent image on the charged surface of the electrophotographic photoreceptor;
a developing section that develops the electrostatic latent image formed on the surface of the electrophotographic photoreceptor with a developer containing a toner to form a toner image; and
a transfer section that includes the transfer unit according to claim 11 and transfers the toner image formed on the surface of the electrophotographic photoreceptor to a surface of a recording medium through the endless belt.

20. The image forming apparatus according to claim 17,
wherein a process speed is 180 mm/s or higher.
